(19) United States
(12) Patent Application Publication
(10) Pub. No.: US 2015/0134700 A1
(43) Pub. Date: May 14, 2015

(54) TERMINATING USER ACCESS TO DATABASE SYSTEMS

(71) Applicant: salesforce.com, inc., San Francisco, CA (US)

(72) Inventors: Walter Macklem, San Francisco, CA (US); Daniel Donovan, San Francisco, CA (US); Shawna Wolverton, Oakland, CA (US); Cameron Reynolds-Flatt, San Francisco, CA (US)

(21) Appl. No.: 14/541,462

(22) Filed: Nov. 14, 2014

Related U.S. Application Data
(60) Provisional application No. 61/904,110, filed on Nov. 14, 2013.

(51) Int. Cl. G06F 17/30; G06F 21/60; G06F 21/62

(52) U.S. Cl. CPC G06F 17/30289; G06F 21/6218; G06F 21/604; G06F 2221/2113; G06F 2221/2145
USPC 707/781

(57) ABSTRACT

Terminating user access to database systems is described. A system receives, from a user interface associated with a system administrator, a request to terminate access by a user of a database system. The system terminates access by the user to the database system, without deleting an account associated with the user from an association with data and/or a workflow associated with the database system.

### CLAIM OF PRIORITY

This application claims the benefit of U.S. Provisional Patent Application No. 61/904,110 entitled, SYSTEM AND METHOD FOR TERMINATING USER ACCESS TO ON-DEMAND DATABASE SYSTEMS, by Macklem, et al., filed Nov. 14, 2013, the entire contents of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

A system administrator may not be able to instantly terminate or restrict a user's access to a database system. A system administrator may spend at least a day deactivating a system user by untangling or disentangling the system user's account from data records that the system user created and workflows that involve the system user. Many system administrators use workarounds to restrict a user's access, such as changing a user's login or password without informing the user. However, changing a user's login or password may not have any effect on the user's access to a database system if the user is already accessing the system. Accordingly, it is desirable to provide techniques which enable system administrators to terminate a user's access to a database system.

### BRIEF SUMMARY

In accordance with embodiments, there are provided systems and methods for terminating user access to database systems. A request to terminate access by a user of a database system is received from a user interface associated with a system administrator. Then access by the user to the database system is terminated, without deleting an account associated with the user from an association with data and/or a workflow associated with the database system. For example, a system administrator responds to a large organization releasing a high-level employee by submitting a request via the administrator's mobile phone to immediately deactivate the released employee from accessing a customer relationship management database in an on-demand multi-tenant database system. A “freeze” application programming interface is executed to immediately terminate the released employee's access to the customer relationship management database in the on-demand multi-tenant database system, even if the released employee is currently accessing the customer relationship management database. The system administrator can terminate a user's access to a database system via a mobile application through one tap, instead spending more than a day using a long wizard process in a web application.

While one or more implementations and techniques are described with reference to an embodiment in which terminating user access to database systems is implemented in a system having an application server providing a front end for an on-demand database service capable of supporting multiple tenants, the one or more implementations and techniques are not limited to multi-tenant databases nor deployment on application servers. Embodiments may be practiced using other database architectures, i.e., ORACLE®, DB2® by IBM and the like without departing from the scope of the embodiments claimed.

Any of the above embodiments may be used alone or together with one another in any combination. The one or more implementations encompassed within this specification may also include embodiments that are only partially mentioned or alluded to or are not mentioned or alluded to at all in this brief summary or in the abstract. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

### BRIEF DESCRIPTION OF THE DRAWINGS

In the following drawings like reference numbers are used to refer to like elements. Although the following figures depict various examples, the one or more implementations are not limited to the examples depicted in the figures.

FIG. 1 is an operational flow diagram illustrating a high level overview of a method for terminating user access to database systems, in an embodiment;

FIG. 2 is an example user interface for terminating user access to database systems, in an embodiment;

FIG. 3 illustrates a block diagram of an example of an environment wherein an on-demand database service might be used; and

FIG. 4 illustrates a block diagram of an embodiment of elements of FIG. 3 and various possible interconnections between these elements.

### DETAILED DESCRIPTION

### General Overview

Systems and methods are provided for terminating user access to database systems. As used herein, the term multi-tenant database system refers to those systems in which various elements of hardware and software of the database system may be shared by one or more customers. For example, a given application server may simultaneously process requests for a great number of customers, and a given database table may store rows for a potentially much greater number of customers. As used herein, the term query plan refers to a set of steps used to access information in a database system. Next, mechanisms and methods for terminating user access to database systems will be described with reference to example embodiments. The following detailed description will first describe a method for terminating user access to database systems. Next, an example user interface for terminating user access to database systems is described.

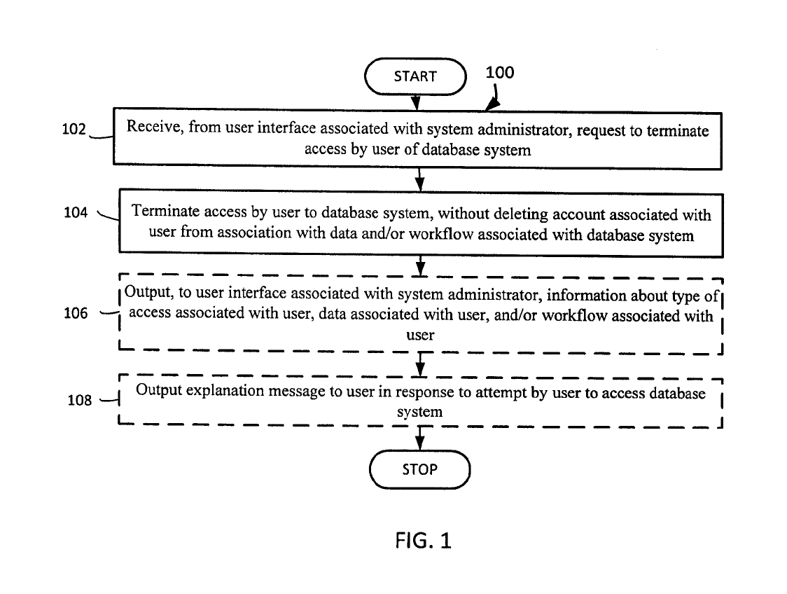

FIG. 1 is an operational flow diagram illustrating a high level overview of a method 100 for terminating user access to database systems. As shown in FIG. 1, a database system may terminate a user's access to the database system.

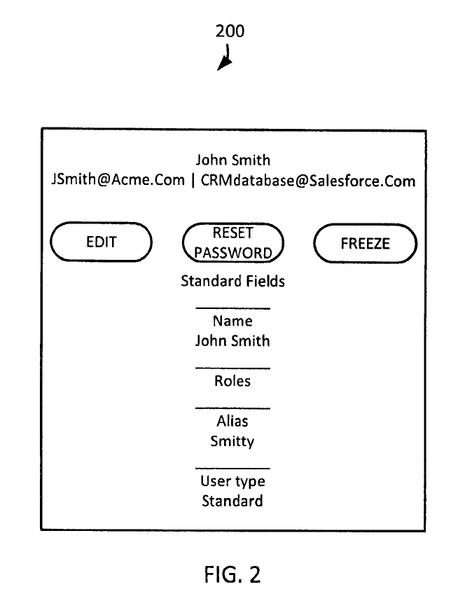

A database system receives a request to terminate access by a user of the database system from a user interface associated with a system administrator, block 102. For example and without limitation, this can include the database system receiving a request to immediately deactivate a released employee from accessing a customer relationship management database in an on-demand multi-tenant database system, from a system administrator's mobile phone application when the administrator responds to information about a large organization releasing the high-level employee. Although this example describes a system administrator requesting to terminate a user's access to a customer relationship management database system, the system administrator may requesting to terminate a user's access to any type of database system. Although this example describes a system administrator using a mobile phone to request to terminate a user's access to a database system, the system administrator may use any type of computing device, mobile or otherwise, to request to terminate a user's access to a database system. An example user interface for terminating user access to database systems is depicted in FIG. 2 and described below in the description of FIG. 2.

Having received the request to terminate a user's access, the database system terminates access by the user to the database system, without deleting an account associated with the user from an association with data and/or a workflow associated with the database system, block 104. By way of example and without limitation, this can include the database system executing a “freeze” application program interface to immediately terminate the released employee's access to the customer relationship management database in the on-demand multi-tenant database system, even if the released employee is currently accessing the customer relationship management database. However, the database system terminates the released employee's access without deleting the employee's user account from ownership of customer relationship management records for leads and cases, which would have created database management problems if these records did not have owners. The database system terminates the released employee's access also without deleting the employee's user account from association with workflows, which would have created problems when the database system attempted to get the released employee's workflow-required approval for specific data entered by one of the released employee's staff members.

The “freeze” application programming interface can terminate any current access session for the released employee, and prevent the released employee from logging back in again, without changing the released employee's password or username. For example, the database system may maintain a table of the various different types of access permissions for all users authorized to access the database system, and a single column in the table may be for a “is frozen?” parameter, such that the “freeze” application programming interface may simply set this parameter for a user to terminate the user's access to the database system. If the organization rehires the released employee, or if the system administrator made a mistake in freezing the employee's account, the system administrator may simply select an option to unfreeze the employee's account, and the employee's username and password are not affected. Although this example describes an application programming interface terminating a user's access to a database system, any combination of software and hardware may terminate the user's access to the database system. The system administrator can terminate a user's access to an on-demand database system via a mobile application through one tap, instead spending more than a day using a long wizard process in a web application.

Having terminated the user's access, the database system may optionally output, to the user interface associated with the system administrator, information about the type of access associated with the user, the data associated with the user, and/or the workflow associated with the user, block 106. In embodiments, this can include the database system informing the system administrator about the released employee's types of access, such as the permissions, the licenses, the private groups, the public groups, and the manager hierarchies, which enables the system administrator to efficiently manage any reassignments necessary. Continuing this example, the system administrator can reassign the data records that need new owners and the workflows that need new approvers at a later and more convenient time, after the released employee's access is already terminated.

After terminated the user's access, the database system may optionally output an explanation message to the user in response to an attempt by the user to access the database system, block 108. For example and without limitation, this can include the database system responding to the user's attempt to login to access the database system by informing the user that the system administrator has frozen the user's account, and providing contact information for the system administrator if the user believes that the system administrator has erroneously frozen the user's account. The database system may execute an audit program to track freezes of user accounts by system administrators and any communications from the users to the system administrators requesting for the user accounts to be unfrozen.

The method 100 may be repeated as desired. Although this disclosure describes the blocks 102-108 executing in a particular order, the blocks 102-108 may be executed in a different order. In other implementations, each of the blocks 102-108 may also be executed in combination with other blocks and/or some blocks may be divided into a different set of blocks.

FIG. 2 illustrates an example user interface 200 for terminating user access to database systems, under an embodiment. A system administrator may use the user interface 200 when editing a user's account information, resetting a user's password, or terminating a user's access to a database system.

### System Overview

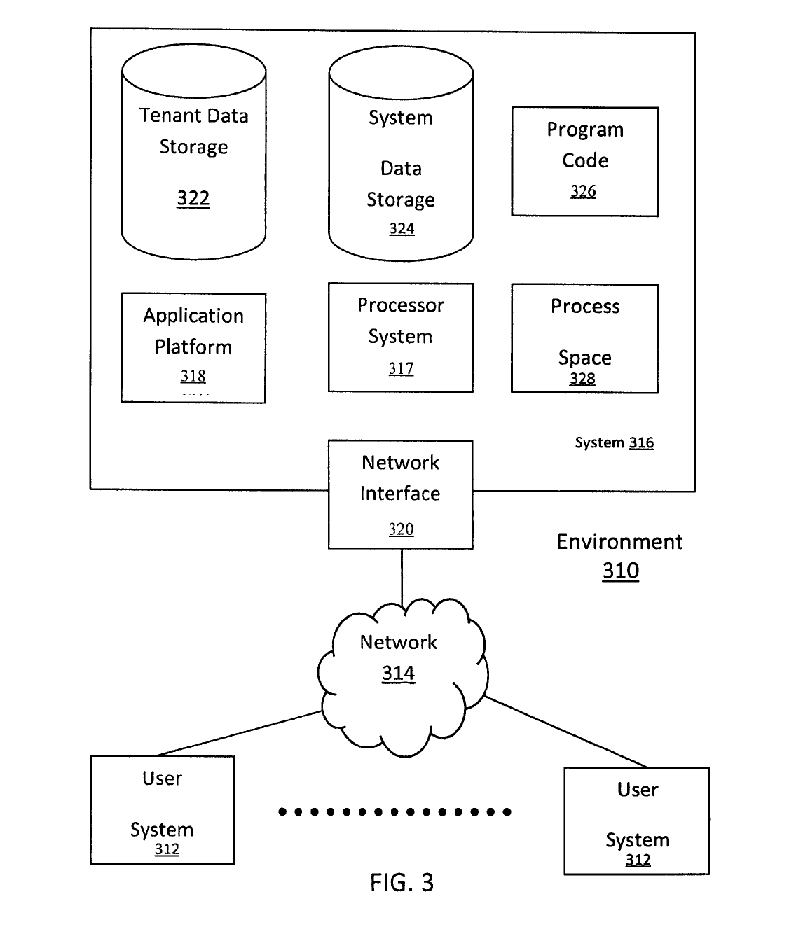

FIG. 3 illustrates a block diagram of an environment 310 wherein an on-demand database service might be used. The environment 310 may include user systems 312, a network 314, a system 316, a processor system 317, an application platform 318, a network interface 320, a tenant data storage 322, a system data storage 324, program code 326, and a process space 328. In other embodiments, the environment 310 may not have all of the components listed and/or may have other elements instead of, or in addition to, those listed above.

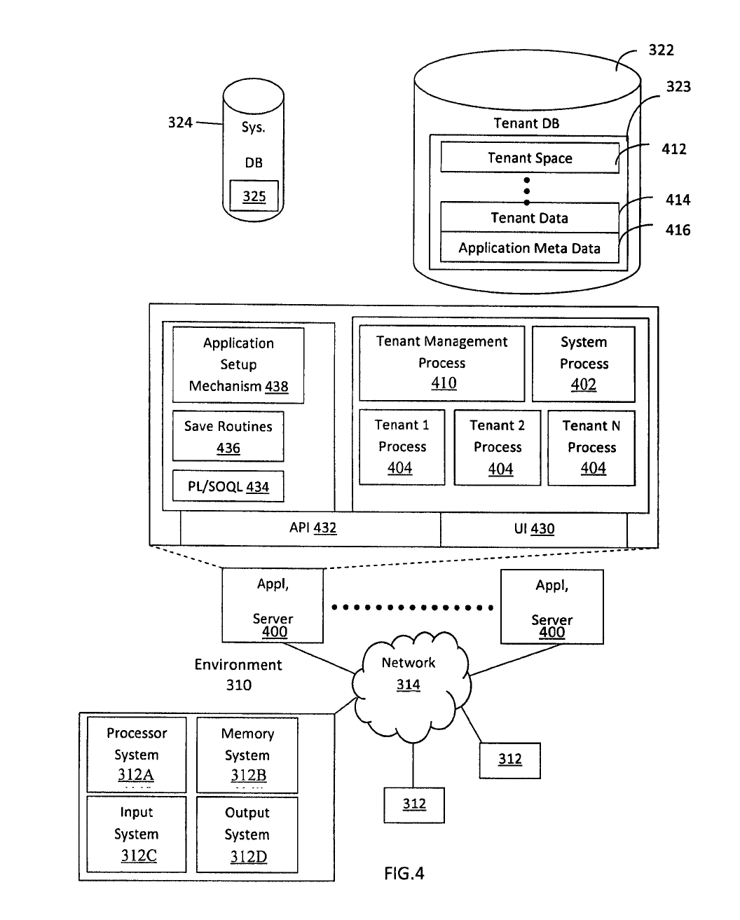

The environment 310 is an environment in which an on-demand database service exists. A user system 312 may be any machine or system that is used by a user to access a database user system. For example, any of the user systems 312 may be a handheld computing device, a mobile phone, a laptop computer, a work station, and/or a network of computing devices. As illustrated in FIG. 3 (and in more detail in FIG. 4) the user systems 312 might interact via the network 314 with an on-demand database service, which is the system 316.

An on-demand database service, such as the system 316, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, the “on-demand database service 316” and the “system 316” will be used interchangeably herein. A database image may include one or more database objects. A relational database management system (RDMS) or the equivalent may execute storage and retrieval of information against the database object(s). The application platform 318 may be a framework that allows the applications of the system 316 to run, such as the hardware and/or software, e.g., the operating system. In an embodiment, the on-demand database service 316 may include the application platform 318 which enables creation, managing and executing one or more applications developed by the provider of the on-demand database service, users accessing the on-demand database service via user systems 312, or third party application developers accessing the on-demand database service via the user systems 312.

The users of the user systems 312 may differ in their respective capacities, and the capacity of a particular user system 312 might be entirely determined by permissions (permission levels) for the current user. For example, where a salesperson is using a particular user system 312 to interact with the system 316, that user system 312 has the capacities allotted to that salesperson. However, while an administrator is using that user system 312 to interact with the system 316, that user system 312 has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

The network 314 is any network or combination of networks of devices that communicate with one another. For example, the network 314 may be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that the one or more implementations might use are not so limited, although TCP/IP is a frequently implemented protocol.

The user systems 312 might communicate with the system 316 using TCP/IP and, at a higher network level, use other common Internet protocols to communicate, such as HTTP, FTP, AFS, WAP, etc. In an example where HTTP is used, the user systems 312 might include an HTTP client commonly referred to as a “browser” for sending and receiving HTTP messages to and from an HTTP server at the system 316. Such an HTTP server might be implemented as the sole network interface between the system 316 and the network 314, but other techniques might be used as well or instead. In some implementations, the interface between the system 316 and the network 314 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, the system 316, shown in FIG. 3, implements a web-based customer relationship management (CRM) system. For example, in one embodiment, the system 316 includes application servers configured to implement and execute CRM software applications as well as provide related data, code, forms, webpages and other information to and from the user systems 312 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, the system 316 implements applications other than, or in addition to, a CRM application. For example, the system 316 may provide tenant access to multiple hosted (standard and custom) applications, including a CRM application. User (or third party developer) applications, which may or may not include CRM, may be supported by the application platform 318, which manages creation, storage of the applications into one or more database objects and executing of the applications in a virtual machine in the process space of the system 316.

One arrangement for elements of the system 316 is shown in FIG. 3, including the network interface 320, the application platform 318, the tenant data storage 322 for tenant data 323, the system data storage 324 for system data 325 accessible to the system 316 and possibly multiple tenants, the program code 326 for implementing various functions of the system 316, and the process space 328 for executing MTS system processes and tenant-specific processes, such as running applications as part of an application hosting service. Additional processes that may execute on the system 316 include database indexing processes.

Several elements in the system shown in FIG. 3 include conventional, well-known elements that are explained only briefly here. For example, each of the user systems 312 could include a desktop personal computer, workstation, laptop, PDA, cell phone, or any wireless access protocol (WAP) enabled device or any other computing device capable of interfacing directly or indirectly to the Internet or other network connection. Each of the user systems 312 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of the user systems 312 to access, process and view information, pages and applications available to it from the system 316 over the network 314. Each of the user systems 312 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by the system 316 or other systems or servers. For example, the user interface device may be used to access data and applications hosted by the system 316, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each of the user systems 312 and all of its components are operator configurable using applications, such as a browser, including computer code run using a central processing unit such as an Intel Pentium® processor or the like. Similarly, the system 316 (and additional instances of an MTS, where more than one is present) and all of their components might be operator configurable using application(s) including computer code to run using a central processing unit such as the processor system 317, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring the system 316 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, the system 316 is configured to provide webpages, forms, applications, data and media content to the user (client) systems 312 to support the access by the user systems 312 as tenants of the system 316. As such, the system 316 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 4 also illustrates the environment 310. However, in FIG. 4 elements of the system 316 and various interconnections in an embodiment are further illustrated. FIG. 4 shows that the each of the user systems 312 may include a processor system 312A, a memory system 312B, an input system 312C, and an output system 312D. FIG. 4 shows the network 314 and the system 316. FIG. 4 also shows that the system 316 may include the tenant data storage 322, the tenant data 323, the system data storage 324, the system data 325, a User Interface (UI) 430, an Application Program Interface (API) 432, a PL/SOQL 434, save routines 436, an application setup mechanism 438, applications servers 4001-400N, a system process space 402, tenant process spaces 404, a tenant management process space 410, a tenant storage area 412, a user storage 414, and application metadata 416. In other embodiments, the environment 310 may not have the same elements as those listed above and/or may have other elements instead of, or in addition to, those listed above.

The user systems 312, the network 314, the system 316, the tenant data storage 322, and the system data storage 324 were discussed above in FIG. 3. Regarding the user systems 312, the processor system 312A may be any combination of one or more processors. The memory system 312B may be any combination of one or more memory devices, short term, and/or long term memory. The input system 312C may be any combination of input devices, such as one or more keyboards, mice, trackballs, scanners, cameras, and/or interfaces to networks. The output system 312D may be any combination of output devices, such as one or more monitors, printers, and/or interfaces to networks. As shown by FIG. 4, the system 316 may include the network interface 320 (of FIG. 3) implemented as a set of HTTP application servers 400, the application platform 318, the tenant data storage 322, and the system data storage 324. Also shown is the system process space 402, including individual tenant process spaces 404 and the tenant management process space 410. Each application server 400 may be configured to access tenant data storage 322 and the tenant data 323 therein, and the system data storage 324 and the system data 325 therein to serve requests of the user systems 312. The tenant data 323 might be divided into individual tenant storage areas 412, which can be either a physical arrangement and/or a logical arrangement of data. Within each tenant storage area 412, the user storage 414 and the application metadata 416 might be similarly allocated for each user. For example, a copy of a user's most recently used (MRU) items might be stored to the user storage 414. Similarly, a copy of MRU items for an entire organization that is a tenant might be stored to the tenant storage area 412. The UI 430 provides a user interface and the API 432 provides an application programmer interface to the system 316 resident processes to users and/or developers at the user systems 312. The tenant data and the system data may be stored in various databases, such as one or more Oracle™ databases.

The application platform 318 includes the application setup mechanism 438 that supports application developers' creation and management of applications, which may be saved as metadata into the tenant data storage 322 by the save routines 436 for execution by subscribers as one or more tenant process spaces 404 managed by the tenant management process 410 for example. Invocations to such applications may be coded using the PL/SOQL 434 that provides a programming language style interface extension to the API 432. A detailed description of some PL/SOQL language embodiments is discussed in commonly owned U.S. Pat. No. 7,730,478 entitled, METHOD AND SYSTEM FOR ALLOWING ACCESS TO DEVELOPED APPLICATIONS VIA A MULTI-TENANT ON-DEMAND DATABASE SERVICE, by Craig Weissman, filed Sep. 21, 2007, which is incorporated in its entirety herein for all purposes. Invocations to applications may be detected by one or more system processes, which manages retrieving the application metadata 416 for the subscriber making the invocation and executing the metadata as an application in a virtual machine.

Each application server 400 may be communicably coupled to database systems, e.g., having access to the system data 325 and the tenant data 323, via a different network connection. For example, one application server 4001 might be coupled via the network 314 (e.g., the Internet), another application server 400N−1 might be coupled via a direct network link, and another application server 400N might be coupled by yet a different network connection. Transfer Control Protocol and Internet Protocol (TCP/IP) are typical protocols for communicating between application servers 400 and the database system. However, it will be apparent to one skilled in the art that other transport protocols may be used to optimize the system depending on the network interconnect used.

In certain embodiments, each application server 400 is configured to handle requests for any user associated with any organization that is a tenant. Because it is desirable to be able to add and remove application servers from the server pool at any time for any reason, there is preferably no server affinity for a user and/or organization to a specific application server 400. In one embodiment, therefore, an interface system implementing a load balancing function (e.g., an F5 Big-IP load balancer) is communicably coupled between the application servers 400 and the user systems 312 to distribute requests to the application servers 400. In one embodiment, the load balancer uses a least connections algorithm to route user requests to the application servers 400. Other examples of load balancing algorithms, such as round robin and observed response time, also can be used. For example, in certain embodiments, three consecutive requests from the same user could hit three different application servers 400, and three requests from different users could hit the same application server 400. In this manner, the system 316 is multi-tenant, wherein the system 316 handles storage of, and access to, different objects, data and applications across disparate users and organizations.

As an example of storage, one tenant might be a company that employs a sales force where each salesperson uses the system 316 to manage their sales process. Thus, a user might maintain contact data, leads data, customer follow-up data, performance data, goals and progress data, etc., all applicable to that user's personal sales process (e.g., in the tenant data storage 322). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by the system 316 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, the system 316 might also maintain system level data usable by multiple tenants or other data. Such system level data might include industry reports, news, postings, and the like that are sharable among tenants.

In certain embodiments, the user systems 312 (which may be client systems) communicate with the application servers 400 to request and update system-level and tenant-level data from the system 316 that may require sending one or more queries to the tenant data storage 322 and/or the system data storage 324. The system 316 (e.g., an application server 400 in the system 316) automatically generates one or more SQL statements (e.g., one or more SQL queries) that are designed to access the desired information. The system data storage 324 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. Pat. No. 7,779,039, filed Apr. 2, 2004, entitled “Custom Entities and Fields in a Multi-Tenant Database System”, which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

1. A system for terminating user access to database systems, the apparatus comprising:
one or more processors; and
a non-transitory computer readable medium storing a plurality of instructions, which when executed, cause the one or more processors to:
receive, from a user interface associated with a system administrator, a request to terminate access by a user of a database system; and
terminate access by the user to the database system, without deleting an account associated with the user from an association with at least one of data and a workflow associated with the database system.

2. The system of claim 1, wherein the user interface is associated with a mobile device.

3. The system of claim 1, wherein the database system comprises a customer relationship management system database.

4. The system of claim 1, wherein the database system is accessed via an on-demand database system.

5. The system of claim 1, wherein terminating access by the user to the database system comprises at least one of terminating a current access session associated with the user and preventing the user from initiating access to the database system.

6. The system of claim 1, comprising further instructions, which when executed, cause the one or more processors to output, to the user interface associated with the system administrator, information about at least one of a type of access associated with the user, the data associated with the user, and the workflow associated with the user.

7. The system of claim 1, comprising further instructions, which when executed, cause the one or more processors to output a message to the user in response to an attempt by the user to access the database system.

8. A computer program product comprising computer-readable program code to be executed by one or more processors when retrieved from a non-transitory computer-readable medium, the program code including instructions to:
receive, from a user interface associated with a system administrator, a request to terminate access by a user of a database system; and
terminate access by the user to the database system, without deleting an account associated with the user from an association with at least one of data and a workflow associated with the database system.

9. The computer program product of claim 8, wherein the user interface is associated with a mobile device.

10. The computer program product of claim 8, wherein the database system comprises a customer relationship management system database.

11. The computer program product of claim 8, wherein the database system is accessed via an on-demand database system.

12. The computer program product of claim 8, wherein terminating access by the user to the database system comprises at least one of terminating a current access session associated with the user and preventing the user from initiating access to the database system.

13. The computer program product of claim 8, wherein the program code comprises further instructions to output, to the user interface associated with the system administrator, information about at least one of a type of access associated with the user, the data associated with the user, and the workflow associated with the user, and output an explanation message to the user in response to an attempt by the user to access the database system.

14. A method for terminating user access to database systems, the method comprising:
receiving, from a user interface associated with a system administrator, a request to terminate access by a user of a database system; and
terminating access by the user to the database system, without deleting an account associated with the user from an association with at least one of data and a workflow associated with the database system.

15. The method of claim 14, wherein the user interface is associated with a mobile device.

16. The method of claim 14, wherein the database system comprises a customer relationship management system database.

17. The method of claim 14, wherein the database system is accessed via an on-demand database system.

18. The method of claim 14, wherein terminating access by the user to the database system comprises at least one of terminating a current access session associated with the user and preventing the user from initiating access to the database system.

19. The method of claim 14, the method further comprising outputting, to the user interface associated with the system administrator, information about at least one of a type of access associated with the user, the data associated with the user, and the workflow associated with the user.

20. The method of claim 15, the method further comprising outputting an explanation message to the user in response to an attempt by the user to access the database system.
